(19) United States
(12) Patent Application Publication
(10) Pub. No.: US 2011/0201721 A1
(43) Pub. Date: Aug. 18, 2011

(54) ACETONE-BASED SOLUTION OF A VINYL RESIN

(75) Inventors: A. Richard Koetzle, Rochester, NY (US); Pamela Geddes, Alden, NY (US); John R. Przybylo, West Seneca, NY (US); Daniel J. Harrison, Pittsford, NY (US)

(73) Assignee: Tarksol, Inc.

(21) Appl. No.: 13/038,666

(22) Filed: Mar. 2, 2011

Related U.S. Application Data
(63) Continuation-in-part of application No. PCT/US2009/055701, filed on Sep. 2, 2009.
(60) Provisional application No. 61/093,554, filed on Sep. 2, 2008.

(51) Int. Cl. C09D 5/16; C08K 5/07; C08K 5/101; C08K 5/12; B05D 7/24; B05D 3/00

(52) U.S. Cl. 523/122; 524/365; 524/315; 524/296; 427/385.5

(57) ABSTRACT

Disclosed in this specification is a method and composition for producing a coating of a poly(vinyl chloride) (PVC) resin from an acetone-based solution. The solution includes a coating facilitator with terpineol and/or tertbutyl acetate. The coating facilitator also includes a second compound with a boiling point of at least 100° C. that acts to promote the solubility of the PVC resin. Also disclosed is an acetone-based solvent system that includes an additive selected from a terpene, diacetone alcohol and t-butyl acetate.

### CROSS REFERENCE TO RELATED APPLICATIONS

This application is a continuation-in-part of co-pending international patent application US2009/055701, filed on Sep. 2, 2009 which claims priority from U.S. provisional application U.S. Ser. No. 61/093,554, filed Sep. 2, 2008. The content of these applications are hereby incorporated by reference into this specification in their entirety.

### FIELD OF THE INVENTION

This invention relates, in one embodiment, to a composition and method for producing a poly(vinyl chloride) coating from an acetone-based solution. The coatings produced by such solutions provide resistance to chemicals, oils and salts and find particular utility in marine applications. Another embodiment pertains to an acetone-based solvent including an additive such as a terpene, diacetone alcohol and/or t-butyl acetate. Such solvents are useful as cleaning solutions in addition to their coating applications.

### BACKGROUND OF THE INVENTION

Due to their chemical durability, vinyl polymeric coatings have been used to protect substrates which are exposed to harsh environments. For example, marine vinyl coatings (MVC) often include vinyl resins as a major component. To provide protection from environmental damage, such resins must be insoluble in water. Accordingly, organic solvents are often used during the coating process. Unfortunately, the solubility of poly(vinyl chloride) reins (PVC) in organic solvents is rather limiting. Those solvent systems that do solvate PVC resins are often regulated as a volatile organic compound (VOC), which greatly complicates the pragmatic aspects of commercializing such resins. Some solvents have been exempted from VOC regulations, but the solubility of PVC in these VOC-exempt solvents is low and/or there are additional complications caused by such solvents.

For example, acetone is one of the few VOC-exempt solvents that will solvate PVC. However, if one attempts to coat a PVC resin from an acetone solution, the acetone evaporates too quickly. PVC resins deposited from such solutions do not cure properly and the resulting coatings do not provide the desired level of chemical protection. Additionally, if the coating is sprayed the acetone evaporations in the midst of the spraying process which results in a “spidering” of the resin during coating.

Therefore, there is a need for a PVC composition that may be properly coated from an acetone-based solution.

### SUMMARY OF THE INVENTION

An advantage of the present invention is that the poly(vinyl chloride) resins may be coated from an inexpensive and VOC-exempt solvent.

A further advantage of the present invention is that the resulting vinyl coatings made from solutions that include terpineol have improved properties relative to coatings made without terpineol.

In addition, it is desirable to have a range of suitable coating solvents and it would be advantageous to broaden the available options.

### DETAILED DESCRIPTION

In one embodiment, the invention is a solution of a poly(vinyl chloride) (PVC) resin dissolved in an acetone solution doped with a coating facilitator. The coating facilitator preferably includes a first and second compound. The first compound facilitates the deposition of the PVC resin. The second compound helps solvate the PVC resin without disrupting the coating properties imparted by the first compound.

Examples of the first compound include terpineol and tertbutyl acetate. The word “Terpineol” is commonly used to refer to one or more isomeric terpene alcohols. There are three common isomers: alpha-terpineol, beta-terpineol, and gamma-terpineol. Commercial terpineol is typically a mixture that includes these isomers with alpha-terpineol being the more common isomer.

The second compound is a relatively high-boiling (>100° C.) organic solvent that facilitates the solvation of the PVC resin. Examples of suitable second compounds include cyclohexanone and cyclopentanone, although other compounds which dissolve PVC and have a relatively high-boiling point may also be used. One such second compound is 4-chloro-α,α,α-trifluorotoluene available under the commercial name Oxsol®.

The solutions are acetone-based (i.e. at least 50% (m/m) acetone). In one embodiment, the acetone concentration of the solution is from 50% (m/m) to about 70% (m/m). The solution generally includes from about 1% (m/m) to about 30% (m/m) of a coating facilitator that includes at least two compounds. The balance of the mass includes the PVC resin itself as well as plasticizers, dispersants, pigments/colorants, primers, anti-fouling agents, and other additives. The first compound in the coating facilitator helps deposit the PVC resin by retarding the evaporation of the acetone during coating. The first compound may be terpineol, tertbutyl acetate or a mixture of the two. Other suitable compounds may also be used to achieve the same effect, but terpineol and tertbutyl acetate are preferred, as such compounds are exempt from VOC regulations. Since PVC is only sparingly soluble in both terpineol and tertbutyl acetate, a second compound is included in the coating facilitator. The second compound is selected to help solvate the PVC resin. The second compound has a boiling point that will prevent its rapid evaporation, which would negatively affect the resulting coat. Examples of suitable second compounds include cyclohexanone and cyclopentane, although a wide variety of suitable organic solvents would be apparent to the reader after benefiting from reading this specification. Although not wishing to be bound to any particular theory, the coating facilitator appears to alter the rate of evaporation of the solution so as to permit PVC resins to be coated from acetone-based solutions. The amount of coating facilitator necessary varies from solution to solution depending on a number of variables including the composition of the PVC resin, the additives in the solution, and the like. The concentration of the coating facilitator relative to the volume of solution is generally between 1% and 30% (m/m). In another embodiment, the concentration is between 5% and 15%. In yet another embodiment, the concentration is about 10%. In other embodiments, the concentration of the coating facilitator is selected to permit the coating of the PVC resin such that it will not peel when tested in accordance with Army Corp of Engineers Unified Facilities Guide Specifications UFGS-09965A. To the solution, additional components may be added, thus producing paints. For example, pigments or other colorants may be added. The aforementioned concentrations are based on the volume of the solution before any additional components have been added, as opposed to the volume of the paint after such components have been added.

The relative composition of the first and second compound may be adjusted to tune the properties of the final coating and adjust for the specific nature of the resin currently being used. Although the precise amount/composition of coating facilitator necessary to cause the PVC resin to coat properly varies depending on the nature of the resin and the desired properties of the coated substrate, the reader will be guided by the examples disclosed in this specification. After benefiting from such guidance, simple experimentation allows the proper concentration and composition to be determined through routine tests. In one embodiment, the second compound is at least 50% of the composition of the coating facilitator. In another embodiment, the second compound is at least 70% of the composition of the facilitator. The remainder of the facilitator is the first compound and trace impurities. For example, the coating facilitator may be about 75% cyclohexanone and about 25% terpineol. Another coating facilitator is about 75% cyclohexanone and about 25% tertbutyl acetate.

A variety of additives may be added to the PVC solution to produce specific paints. Such additives are well known in the art and include plasticizers (typically phthalate esters), pigments/colorants (such as TiO₂ as well as many others), dispersants to disperse pigments and other additives, primers (typically acids, such as phosphoric acid), and anti-fouling agents that prevent the growth of biological organisms on the coated substrate. Vinyl coatings deposited from prior art solutions, such as toluene/methyl isobutyl ketone solutions, experience adhesion problems when dispersants are used. Advantageously, the vinyl coatings deposited from the solutions from the present invention do not experience such adhesion difficulties when dispersants are used. See example 7 versus comparative example 3 and 4, which illustrate this novel feature.

A PVC coating may be disposed on a substrate by coating the substrate with the PVC/acetone/facilitator solution and thereafter permitting the acetone to evaporate. Advantageously, the facilitator present in the original solution alters the properties of the resulting vinyl coating. The vinyl coating, after evaporation of the acetone, retains trace terpineol/tertbutyl acetate. Without wishing to be bound to any particular theory, the inventor believes the residual facilitator becomes trapped within the vinyl resin and acts as a plasticizier. The resulting vinyl coatings have improved properties relative to vinyl coatings which lack the facilitator.

The following examples are for purposes of illustration and should not be read as limiting the invention in any sense. In the following examples, two resins mixtures were used. The first mixture was a combination of VYHH (The DOW Chemical Co., Midland, Mich. 48674, 14% vinyl acetate, 85% vinyl chloride, molecular weight 27,000) and VMCH (The DOW Chemical Co., Midland, Mich. 48674, 13% vinyl acetate, 85% vinyl chloride, 1% maleic acid, molecular weight 27,000, carboxy functionalized). The second mixtures was a combination if VAGH (The DOW Chemical Co., Midland, Mich. 48674, 4% vinyl acetate, 90% vinyl chloride, molecular weight 27,000, hydroxy functionalized). The adhesion tests were conducted in accordance with Army Corp of Engineers Unified Facilities Guide Specifications UFGS-09965A.

| | | | | Test |
|---|---|---|---|---|
| Example | Solvent | Resin | Dispersant | results |
| 1 | acetone | VYHH/VMCH | No | Unusable |
| 2 | A | VYHH/VMCH | No | Pass |
| 3 | A | VAGH/VMCH | Yes | Fail |
| 4 | A | VYHH/VMCH | Yes | Fail |
| 5 | B | VAGH/VMCH | No | Pass |
| 6 | B | VYHH/VMCH | No | Pass |
| 7 | B | VYHH/VMCH | Yes | Pass |
| 8 | C | VAGH/VMCH | No | Pass |
| 9 | C | VYHH/VMCH | No | Pass |

A = toluene/methyl isobutyl ketone
B = acetone/terpineol/cyclohexanone
C = acetone/tertbutyl acetate/cyclohexanone

### Example 1

### Acetone without Coating Facilitator

This sample was prepared by making a solvent mixture by adding 66.7 grams of acetone (Univar, Redmond, Wash.), and 2.9 grams of di-isodecyl phthalate (Ashland Chemical, Columbus, Ohio 43216) plasticizer, to a glass beaker fitted with a magnetic stir bar. To the solvent-plasticizer mixture 5.6 grams of the UCAR VYHH polyvinylchloride copolymer (The DOW Chemical Co., Midland, Mich. 48674) was added slowly with vigorous stirring until the resins dissolved completely and the solution went clear. Then 11.6 grams of the UCAR VMCH polyvinylchloride copolymer (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. Then a 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC (volatile organic content) on this sample is 0 gm/L.

The above paint was not able to be applied to cold rolled steel coupons (Paul N. Gardco, Pompano Beach, Fla.) via pressure spray application because the paint would dry in the air before hitting the coupon.

### Example 2

### VYHH/VMCH from Toluene/Methyl Isobutyl Ketone with No Dispersant

This sample was prepared by making a solvent mixture by adding 34.7 grams of toluene (Univar, Redmond, Wash.) 32 grams of methyl isobutyl ketone (Univar, Redmond, Wash.), and 2.9 grams of di-isodecyl pthalate (Ashland Chemical, Columbus, Ohio 43216) plasticizer, to a glass beaker fitted with a magnetic stir bar. To the solvent-plasticizer mixture 5.6 grams of the UCAR VYHH polyvinylchloride copolymer (The DOW Chemical Co., Midland, Mich. 48674) was added slowly with vigorous stirring until the resins dissolved completely and the solution went clear. Then 11.6 grams of the UCAR VMCH polyvinylchloride copolymer (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. Then a 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC (volatile organic content) on this sample is 688.94 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.0 mil to 4.2 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide, Specifications UFGS-09965A and were found to pass.

### Example 3

### VAGH/VMCH from Toluene/Methyl Isobutyl Ketone with Dispersant

This sample was prepared by making a solvent mixture by adding 32.15 grams of toluene (Univar, Redmond, Wash.), 2.9 grams of dioctyl phthalate (Ashland Chemical, Columbus, Ohio 43216), 34 grams of methyl isobutyl ketone (Univar, Redmond, Wash.), 0.55 grams of Disperbyk 180 (Byk-Chemie, Wallingform, Conn.) to a glass beaker fitted with a magnetic stir bar. To the solvent mixture 5.6 grams of the polyvinylchloride copolymer UCAR VAGH (The DOW Chemical Co., Midland, Mich. 48674) was added slowly with vigorous stirring until the resins dissolved completely and the solution went clear. Then 11.6 grams of the polyvinylchloride copolymer UCAR VMCH (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. A 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC was 683.26 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 1.7 mil to 3.7 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to fail.

### Example 4

### VYHH/VMCH from Toluene/Methyl Isobutyl Ketone with Dispersant

This sample was prepared by making a solvent mixture by adding 32.15 grams of toluene (Univar, Redmond, Wash.), 2.9 grams of dioctyl phthalate (Ashland Chemical, Columbus, Ohio 43216), 34 grams of methyl isobutyl ketone (Univar, Redmond, Wash.), 0.55 grams of Disperbyk 180 (Byk-Chemie, Wallingform, Conn.) to a glass beaker fitted with a magnetic stir bar. To the solvent mixture 5.6 grams of the polyvinylchloride copolymer UCAR VYHH (The DOW Chemical Co., Midland, Mich. 48674) was added slowly with vigorous stirring until the resins dissolved completely and the solution went clear. Then 11.6 grams of the polyvinylchloride copolymer UCAR VMCH (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. A 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC was 604.00 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.6 mil to 3.0 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to fail.

### Example 5

### VAGH/VMCH from Acetone/Terpineol/Cyclohexanone without Dispersant

This sample was prepared by making a solvent mixture by adding 56.18 grams of acetone (Univar, Redmond, Wash.), 2.45 grams of alpha turpineol (International Flavors and Fragrances, New York, N.Y.), 8.07 grams of cyclohexanone (Allied Signal, Morristown, N.J. 07962-1033) and 2.9 grams of dioctyl phthalate (Ashland Chemical, Columbus, Ohio 43216) plasticizer, to a glass beaker fitted with a magnetic stir bar. To the solvent-plasticizer mixture 5.6 grams of the UCAR VAGH polyvinylchloride copolymer (The DOW Chemical Co., Midland, Mich. 48674) was added slowly with vigorous stirring until the resins dissolved completely and the solution went clear. Then 11.6 grams of the UCAR VMCH polyvinylchloride copolymer (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. Then a 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC (volatile organic content) on this sample is 83.35 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.5 mil to 4.5 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to pass.

### Example 6

### VYHH/VMCH from Acetone/Terpineol/Cyclohexanone without Dispersant

This sample was prepared by making a solvent mixture by adding 55.18 grams of acetone (Univar, Redmond, Wash.), 2.9 grams of dioctyl phthalate (Ashland Chemical, Columbus, Ohio 43216), 8.07 grams of cyclohexanone (Allied Signal, Morristown, N.J. 07962-1033), 2.45 grams of alpha turpineol (International Flavors and Fragrances, New York, N.Y.), to a glass beaker fitted with a magnetic stir bar. To the solvent mixture 5.6 grams of the polyvinylchloride copolymer UCAR VYHH (The DOW Chemical Co., Midland, Mich. 48674) was added slowly with vigorous stirring until the resins dissolved completely and the solution went clear. Then 11.6 grams of the polyvinylchloride copolymer UCAR VMCH (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. A 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC was 83.35 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.0 mil to 4.0 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to pass.

### Example 7

### VYHH/VMCH from Acetone/Terpineol/Cyclohexanone with Dispersant

This sample was prepared by making a solvent mixture by adding 55.63 grams of acetone (Univar, Redmond, Wash.), 2.9 grams of dioctyl phthalate (Ashland Chemical, Columbus, Ohio 43216), 8.07 grams of cyclohexanone (Allied Signal, Morristown, N.J. 07962-1033), 2.45 grams of alpha turpineol (International Flavors and Fragrances, New York, N.Y.), and 0.55 grams of Disperbyk 180 (Byk-Chemie, Wallingford, Conn.) to a glass beaker fitted with a magnetic stir bar. To the solvent mixture 5.6 grams of the polyvinylchloride copolymer UCAR VYHH (The DOW Chemical Co., Midland, Mich. 48674) was added slowly with vigorous stirring until the resins dissolved completely and the solution went clear. Then 11.6 grams of the polyvinylchloride copolymer UCAR VMCH (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. A 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC was 83.35 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.1 mil to 4.4 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to pass.

### Example 8

### VAGH/VMCH from Acetone/T-Butyl Acetate/C-Hexanone without Disp.

This sample was prepared by making a solvent mixture by adding 56.18 grams of acetone (Univar, Redmond, Wash.), 2.45 grams of t-butyl acetate (Univar, Refdmond, Wash.) 8.07 grams of cyclohexanone (Allied Signal, Morristown, N.J. 07962-1033) and 2.9 grams of dioctyl phthalate (Ashland Chemical, Columbus, Ohio 43216) plasticizer, to a glass beaker fitted with a magnetic stir bar. To the solvent-plasticizer mixture 5.6 grams of the UCAR VAGH polyvinylchloride copolymer (The DOW Chemical Co., Midland, Mich. 48674) was added slowly with vigorous stirring until the resins dissolved completely and the solution went clear. Then 11.6 grams of the UCAR VMCH polyvinylchloride copolymer (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. Then a 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC (volatile organic content) on this sample is 113.3 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.5 mil to 4.5 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to pass.

### Example 9

### VYHH/VMCH from Acetone/T-Butyl Acetate/C-Hexanone without Disp.

This sample was prepared by making a solvent mixture by adding 56.18 grams of acetone (Univar, Redmond, Wash.), 2.9 grams of dioctyl phthalate (Ashland Chemical, Columbus, Ohio 43216), 8.07 grams of cyclohexanone (Allied Signal, Morristown, N.J. 07962-1033), 2.45 grams of t-butyl acetate (Univar, Redmond, Wash.), to a glass beaker fitted with a magnetic stir bar. To the solvent mixture 5.6 grams of the polyvinylchloride copolymer UCAR VYHH (The DOW Chemical Co., Midland, Mich. 48674) was added slowly with vigorous stirring until the resins dissolved completely and the solution went clear. Then 11.6 grams of the polyvinylchloride copolymer UCAR VMCH (The DOW Chemical Co., Midland, Mich. 48674) was added slowly with vigorous stirring to the solvent mixture and allowed to stir until the solution was clear. This solution was transferred to a polypropylene bottle. Fifty grams of ceramic grinding media was added to the bottle. Then 13 grams of the Tiona 696 Titanium dioxide (Millenium Inorganic Chemicals, Brussels, Belgium) were added to the bottle. The bottle was placed in a Red Devil paint shaker and shaken for 16 minutes. The ceramic media was filtered out of the paint via a 400 micron mesh filter bag. A hegman grind gauge was used to determine the pigment dispersion of a 7 according to ASTM D 1210. A 20.48% ortho-phosphoric acid solution was made by diluting 0.2 grams of 85% ortho-phosphoric acid (Sigma-Aldrich, Milwaukee, Wis.) with 0.8 grams of acetone. Then 1.0 gram of the 20.48% ortho-phosphoric acid solution was then slowly added under vigorous stirring to the paint described above. The final VOC was 113.3 gm/L.

The above paint was applied to a cold rolled steel coupon (Paul N. Gardco, Pompano Beach, Fla.) via pressure spray application. The coated coupons were allowed to air dry for 2 hours and then placed in a 120 F oven for 16 hours cure. After 16 hours the coated coupons were removed and allowed to equilibrate at room temperature for one hour. The final dry coatweights were measured with a Byko-test 4500 film thickness gauge (Byk Additives and Instruments, Columbia, Md.) and were in the range of 2.1 mil to 4.4 mil. After equilibration the coupons were placed, on edge so half of the coupon was covered with water, in a water bath inside an oven set to 85-90 F for 48 hours. After 48 hours the coupons removed and blotted dry with a soft cloth. The coupons were immediately tested for adhesion according to the Army Corp of Engineers Unified Facilities Guide Specifications UFGS-09965A and were found to pass.

Other examples of suitable additives include diacetone alcohol and/or t-butyl acetate. By way of further illustration the additive may be a terpene, such as the terpineol (a terpene alcohol) previously discussed, d-limonene (a terpene hydrocarbon), or a combination of terpenes, such as pine oil. Generally terpenes are natural products that are formed from one or more isoprene units. The term terpene includes chemically modified terpenes, which are also referred to as terpeneoids.

| Example | Solvent | Resin | Additive |
|---|---|---|---|
| 10 | D | VMCH | None |
| 11 | E | BR106 Acrylic | None |
| 12 | D | VMCH | α-terpineol |
| 13 | E | BR106 Acrylic | α-terpineol |
| 14 | D | VMCH | d-limonene |
| 15 | E | BR106 Acrylic | d-limonene |
| 16 | D | VMCH | Pine oil |
| 17 | E | BR106 Acrylic | Pine oil |
| 18 | D | VMCH | Diacetone alcohol |
| 19 | E | BR106 Acrylic | Diacetone alcohol |
| 20 | D | VMCH | t-butyl acetate |

D - 62.61% acetone; 14.50% resin; 0.50% Epoxy stabilizer; 13.50% additive; 5.0% TiO₂.
E - 62.61% acetone; 15.0% resin; 15.00% t-butyl acetate; 13.50% additive.

The solvent systems described above may also be used in other, non-coating applications, such as cleaning applications and as degreasers and strippers. In such embodiments the solvents include at least 50% acetone and from about 5% to about 20% of the additive.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

What is claimed is:

1. A solution of poly(vinyl chloride) resin comprising
a poly(vinyl chloride) resin;
an acetone solvent present in a concentration of at least 50% (m/m);
a coating facilitator, present in a concentration from about 1% (m/m) to about 30% (m/m), that includes:
a first compound selected from the group consisting of terpineol, tertbutyl acetate, and combinations thereof;
a second compound with a boiling point of at least 100° C., wherein the poly(vinyl chloride) is soluble in the pure second compound.

2. The solution as recited in claim 1, wherein the acetone is present in a concentration of 50% (m/m) to 70% (m/m).

3. The solution as recited in claim 1, wherein the coating facilitator is present in a concentration of from about 5% to about 15%.

4. The solution as recited in claim 1, wherein the coating facilitator is present in a concentration of about 10%.

5. The solution as recited in claim 1, wherein at least 50% (m/m) of the coating facilitator is the second compound.

6. The solution as recited in claim 1, wherein at least 70% (m/m) of the coating facilitator is the second compound.

7. The solution as recited in claim 6, wherein the first compound is terpineol.

8. The solution as recited in claim 6, wherein the first compound is tertbutyl acetate.

9. The solution as recited in claim 1, further comprising a phthalate plasticizer.

10. The solution as recited in claim 1, further comprising a pigment.

11. The solution as recited in claim 10, further comprising a dispersant for dispersing the pigment.

12. The solution as recited in claim 1, wherein the second compound is a cyclic ketone.

13. The solution as recited in claim 1, wherein the second compound is cyclohexanone or cyclopentanone.

14. The solution as recited in claim 1, wherein the second compound is 4-chloro-α,α, α-trifluorotoluene.

15. The solution as recited in claim 1, further comprising an anti-fouling agent.

16. A method of coating a substrate with a poly(vinyl chloride) resin dissolved in an acetone-based solution comprising the steps of:
coating a substrate with a poly(vinyl chloride) resin solution, the solution including:
a poly(vinyl chloride) resin;
an acetone solvent present in a concentration of at least 50% (m/m);
a coating facilitator, present in a concentration from about 1% (m/m) to about 30% (m/m), that includes:
a first compound selected from the group consisting of terpineol, tertbutyl acetate, and combinations thereof;
a second compound with a boiling point of at least 100° C., wherein the poly(vinyl chloride) is soluble in the pure second compound;
permitting the acetone solvent to evaporate, thus producing a substrate coated with a poly(vinyl chloride) coating.

17. The method as recited in claim 16, wherein the poly(vinyl chloride) resin solution further includes a dispersant.

18. A substrate coated in accordance with the method of claim 16.

19. The substrate as recited in claim 18, wherein the poly(vinyl) chloride coating includes the first compound after the acetone has evaporated.

20. A method of coating a substrate with a poly(vinyl chloride) resin dissolved in an acetone-based solution comprising the steps of:
coating a substrate with a poly(vinyl chloride) resin solution, the solution including:
a poly(vinyl chloride) resin;
an acetone solvent present in a concentration of at least 50% (m/m);
a coating facilitator that includes:
a first compound selected from the group consisting of terpineol, tertbutyl acetate, and combinations thereof;
a second compound with a boiling point of at least 100° C., wherein the poly(vinyl chloride) is soluble in the pure second compound,
permitting the acetone solvent to dry, thus producing a substrate coated with a poly(vinyl chloride) coating, wherein the coating facilitator was present in the resin solution in an effective concentration to permit the poly(vinyl chloride) resin to be coated on the substrate.

21. A solution comprising
an acetone solvent present in a concentration of at least 50% (m/m);
a first compound, present in a concentration from about 5% (m/m) to about 20% (m/m), selected from the group consisting of a terpene, diacetone alcohol, t-butyl acetate, and combinations thereof.

22. The solution as recited in claim 21, wherein the first compound is a terpene.

23. The solution as recited in claim 21, wherein the first compound is a terpene hydrocarbon.

24. The solution as recited in claim 21, wherein the first compound is d-limonene.

25. The solution as recited in claim 21, wherein the first compound is a terpene alcohol.

26. The solution as recited in claim 21, wherein the first compound is terpineol.

27. The solution as recited in claim 21, wherein the first compound is pine oil.

28. The solution as recited in claim 21, wherein the first compound is diacetone alcohol.

29. The solution as recited in claim 21, wherein the first compound is t-butyl acetate.

30. The solution as recited in claim 21, further comprising a polymeric resin.

31. The solution as recited in claim 30, wherein the polymeric resin is selected from the group consisting of a polymeric acrylic resin and a polymeric vinyl resin.

32. The solution as recited in claim 21, further comprising from about 10% (m/m) to about 20% (m/m) t-butyl acetate and from about 5% (m/m) to about 20% (m/m) of the first compound, wherein the first compound is selected from the group consisting of a terpene, diacetone alcohol, and combinations thereof
